(19) United States
(12) Patent Application Publication
(10) Pub. No.: US 2021/0362232 A1
(43) Pub. Date: Nov. 25, 2021

(54) ADDITIVE MANUFACTURING DEVICES WITH MICROMIRRORS

(71) Applicant: Hewlett-Packard Development Company, L.P., Spring, TX (US)

(72) Inventors: Krzysztof Nauka, Palo Alto, CA (US); Seongsik Chang, Palo Alto, CA (US); Kristopher J. Erickson, Palo Alto, CA (US)

(21) Appl. No.: 16/606,045

(22) PCT Filed: Jul. 31, 2018
(86) PCT No.: PCT/US2018/044477

§ 371 Date: Oct. 17, 2019

(51) Int. Cl. B22F 10/12; B22F 12/20; B22F 12/43; B33Y 10/00; B33Y 30/00

(52) U.S. Cl. CPC B22F 10/12; B22F 12/20; B23K 26/703; B33Y 10/00; B33Y 30/00; B22F 12/43

(57) ABSTRACT

A three-dimensional (3D) printing device may include a pulsed electromagnetic radiation source; a build platform to maintain a number of layers of build material thereon and receive pulsed electromagnetic radiation from the pulsed electromagnetic radiation source; a micromirror array to selectively direct the pulsed electromagnetic radiation from the pulsed electromagnetic radiation source to the build material on the build platform; and a coolant tank with coolant therein to cool the micromirror array.

### BACKGROUND

Additive manufacturing systems produce three-dimensional (3D) objects by building up layers of material and combining those layers using adhesives, heat, chemical reactions, and other coupling processes. Additive manufacturing may involve the application of successive layers of material to make solid parts. One example of an additive manufacturing process is three-dimensional (3D) printing. 3D printing may be used in rapid product prototyping, mold generation, mold master generation, and short run manufacturing. Some 3D printing methods use chemical binders or adhesives to bind build materials together. Other 3D printing methods may involve partial curing, thermal merging/fusing, melting, and sintering, among other processes. of the build material, and the mechanism for material coalescence may depend upon the type of build material used. For some materials, partial melting may be accomplished using heat-assisted extrusion, and for some other materials (e.g., polymerizable materials), curing or fusing may be accomplished using, for example, ultra-violet light or infrared light. Additive manufacturing systems make it possible to convert a computer aided design (CAD) model or other digital representation of an object into a physical object. Digital data is processed into slices each defining that part of a layer or layers of build material to be formed into the object.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a three-dimensional (3D) printing device according to an example of the principles described herein.

FIG. 2 is a block diagram of a method of fusing a build material according to an example of the principles described herein.

FIG. 3 is a block diagram of an additive manufacturing device according to an example of the principles described herein.

FIG. 4 is a schematic diagram of an additive manufacturing device according to an example of the principles described herein.

FIG. 5 is a schematic diagram of an additive manufacturing device (500) according to an example of the principles described herein.

FIG. 6 is a schematic diagram of an additive manufacturing device (600) according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In examples of the methods and systems for additive manufacturing of build materials disclosed herein, photonic fusion is used. Photonic fusion may be relatively faster, more efficient, and less expensive than other additive manufacturing processes (e.g., selective laser sintering (SLS), selective laser melting (SLM), scanning electron beam melting, etc.). In examples of photonic fusion as disclosed herein, a build material layer is exposed to electromagnetic radiation. The energy provided by an electromagnetic radiation source exposes the build material layer on a build platform to the electromagnetic radiation. The electromagnetic radiation causes a consolidating transformation of the build material in the exposed layer. In the present specification and in the appended claims, the term “photonic fusion” is meant to be understood as the use of a photon source such as the electromagnetic radiation source. In the examples presented herein, the photons produced by these electromagnetic radiation sources may be produced by an incoherent light source in order to produce a single exposure of light towards an array of micromirrors. The photons from the incoherent light source may heat the build material to the point of coalescing or fusing together of the build material.

Build materials, according to any example presented herein, may include a metal. The metal may be in powder form, i.e., particles. In the present disclosure, the term “particles” means discrete solid pieces of components of the build material. As used herein, the term “particles” does not convey a limitation on the shape of the particles. As examples, the metal particles may be non-spherical, spherical, random shapes, or combinations thereof. The metal particles may also be similarly sized particles or differently sized particles. The individual particle size of each of the metal particles is up to 100 micrometers (μm). In an example, the metal particles may have a particle size ranging from about 1 μm to about 100 μm. In another example, the individual particle size of the metal particles ranges from about 1 μm to about 30 μm. In still another example, the individual particle size of the metal particles ranges from about 2 μm to about 50 μm. In yet another example, the individual particle size of the metal particles ranges from about 5 μm to about 15 μm. As used herein, the term “individual particle size” refers to the particle size of each individual build material particle. As such, when the metal particles have an individual particle size ranging from about 1 μm to about 100 μm, the particle size of each individual metal particle is within the disclosed range, although individual metal particles may have particle sizes that are different than the particle size of other individual metal particles. In other words, the particle size distribution may be within the given range. The particle size of the metal particles refers to the diameter or volume weighted mean/average diameter of the metal particle, which may vary, depending upon the morphology of the particle.

In an example, the metal may be a single phase metallic material composed of one element. In this example, the sintering temperature of the build material may be below the melting point of the single element. In another example, the metal may be composed of two or more elements, which may be in the form of a single phase metallic alloy or a multiple phase metallic alloy. In these other examples, sintering may occur over a range of temperatures.

In some examples the metal is iron or iron alloy. In any of the examples presented herein, the metal is 316 L Stainless steel alloy consisting of up to 18% of Cr, 13% of Ni, 2.5% of Mo, 2% of Mn and balance of Fe. In any example presented herein, the metal is nickel or nickel alloy. In any example presented herein, the metal is Inconel alloy consisting of 20% of up to 23% of Cr, 10% of Mo, 5% of Fe, 4% of Na and Ta, 0.5% of Ti, Mn, and having a balance of Ni. In any example presented herein, the metal is Titanium or Titanium alloy. In any example presented herein, the metal is Ti64Gd23 containing 23% of Gadolinium, about 6% of Aluminum, 3.5% of Vanadium and balance of Titanium. In any example presented herein, the metal is Aluminum or Aluminum alloy. In any example presented herein, the metal is AlSi10Mg consisting of up to 11% of Si and up to 4.5% of Mg, about 0.25% of Fe and having a balance of Al.

As used in the present specification and in the appended claims, the term “subset” or “subgroup” is meant to be understood as a number that is less than a total number of elements but forms a group within the total.

Additionally, as used in the present specification and in the appended claims, the term “electromagnetic radiation” is meant to be understood as any wave of the electromagnetic field propagating through space-time carrying electromagnetic energy. Examples of electromagnetic radiation may include any human-visible and non-visible light including radio waves, infrared waves, human visible light, ultraviolet light, x-rays, and gamma rays among others.

The present specification describes a three-dimensional (3D) printing device that includes a pulsed electromagnetic radiation source; a build platform to maintain a number of layers of build material thereon and receive pulsed electromagnetic radiation from the pulsed electromagnetic radiation source; a micromirror array to selectively direct the pulsed electromagnetic radiation from the pulsed electromagnetic radiation source to the build material on the build platform; and a coolant tank with coolant therein to cool the micromirror array.

The present specification also describes a method of fusing a build material that includes irradiating an array of micromirrors with an electromagnetic radiation source; selectively directing the electromagnetic radiation with the array of micromirrors to a layer of build material deposited onto a build platform; and cooling the array of micromirrors with a coolant.

The present specification further describes an additive manufacturing device that includes a pulsed electromagnetic radiation source; a digital light processing device maintained within a coolant tank full of coolant; electromagnetic radiation corrective optics; and a build platform to receive a layer of build material; wherein the pulsed electromagnetic radiation source selectively reflects electromagnetic radiation off the digital light processing device, towards the electromagnetic radiation corrective optics, and to the build material on the build platform to selectively fuse the build material.

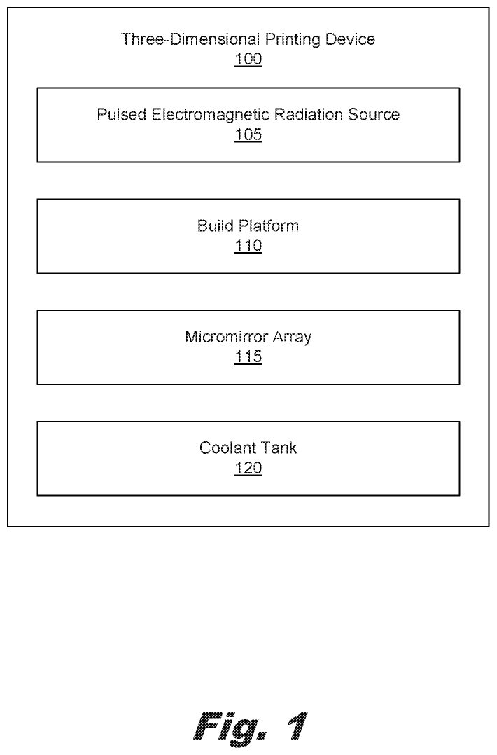

Turning now to the figures, FIG. 1 is a block diagram of a three-dimensional (3D) printing device (100) according to an example of the principles described herein. The 3D printing device (100) may include a pulsed electromagnetic radiation source (105), a build platform (110), a micromirror array (115), and a coolant tank (120). In any example presented herein, the 3D printing device (100) may include a processor to receive computer executable program code that executes the processes and methods described herein. In an example, the processor may send signals to devices within the 3D printing device (100) in order to achieve the manufacturing processes of a 3D object.

The pulsed electromagnetic radiation source (105) may be any type of electromagnetic radiation source that has an intensity and power sufficient to fuse the build material deposited as a layer of build material on the build platform (110). In any example presented herein, the pulsed electromagnetic radiation source (105) may be a Xenon pulsed electromagnetic radiation source, a fiber laser pulsed electromagnetic radiation source, or a vertical-cavity surface-emitting laser (VCSEL), or any other electromagnetic radiation source providing uniform cross-sectional energy density. In an example, the pulsed electromagnetic radiation source (105) may have a flash energy between 4 and 40 Joules per cm² of build material. In an example, the pulsed electromagnetic radiation source (105) may have a flash energy normalized between 400 and 4000 Watts per cm² of build material. The flash energy and normalized flash energy of the pulsed electromagnetic radiation source may be dependent on the type of build material. Table 1 shows example values of the flash energy and normalized flash energy needed to impinge upon the surface of specific types of build materials in order to fuse them.

TABLE 1

| | | | Al | | | Ti |
|---|---|---|---|---|---|---|
| Build Material | PA12 | PEEK | (in AlSi₁₀Mg) | Cu | SS | (inTi₉₀Al₆) |
| Flash energy | 4 | 6 | 30 | 28 | 35 | 34 |
| (J/cm²) | | | | | | |
| Flash energy | 400 | 600 | 3,000 | 2,800 | 3,500 | 3,400 |
| normalized | | | | | | |
| (W/cm²) | | | | | | |

In context of Table 1, PA12 is polyamide 12; PEEK is polyether ether ketone; and SS is stainless steel. The normalized flash energy is normalized to 1 second as expressed as a pulse power rather than a pulse energy in order to account for the system handling of the surge of impinging energy in real time (10 ms energy pulse emitted from the electromagnetic radiation source and impinging on a micromirror array (115) as described herein). Although these certain types of build materials are described, the present specification contemplates the use of any type of build materials including plastics.

In any example presented herein, the 3D printing device (100) may include a build platform (110). The build platform (110) may be any surface onto which the 3D printing device (100) may deposit an amount of build material thereon. In any example presented herein, the 3D printing device (100) may include any deposition device to deposit the build material on the build platform (110). This deposition device may include a hopper to drop sequential layers of build material onto the surface of the build platform (110) and/or onto a surface of a previously deposited layer of build material. A roller or blade may be used to evenly spread the build material on the surface of the build platform (110) and/or over the surface of a previously deposited layer of build material and achieve desired thickness of the newly spread layer. In an example, the build platform (110) may include motors, rails, and other devices that allow the build platform (110) to be moved vertically relative to the direction of electromagnetic radiation directed towards it. In this example, additional layers of build material may be deposited onto the build platform (110) after the build platform (110) is moved vertically down so as to maintain a predefined distance from the pulsed electromagnetic radiation source (105) with each subsequent layer deposition.

The 3D printing device (100) may further include a micromirror array (115). The micromirror array (115) may selectively direct the pulsed electromagnetic radiation from the pulsed electromagnetic radiation source (105) to the build material on the build platform (110). In an example, each of the micromirrors of the micromirror array (115) may be individually driven to reflect the pulsed electromagnetic radiation either towards or away from the build material. This allows for the selective fusing of the build material on each layer of build material deposited on the build platform (110). The portions of the layer of build material fused by the selective direction of the pulsed electromagnetic radiation by the micromirror array (115) may be determined based on computer data such as data derived from a computer-aided design (CAD) file. The data derived from the CAD file may be used to slice a digital representation of a 3D object and fuse selection portions of each layer accordingly to form the 3D object. Any number of techniques may be used to determine this data and, upon execution of computer readable program code, the pulsed electromagnetic radiation source (105) may direct pulsed electromagnetic radiation towards the micromirror array (115) according to that data.

In an example, the number of micromirrors within any micromirror array (115) and/or the number of micromirror arrays (115) may be increased or decreased based on a number of factors. In an example, if a relatively large build platform (110) is being used but a relatively high print resolution is not warranted, a plurality of micromirror arrays (115) may be used to direct electromagnetic radiation to different portions of the build platform (110). In this example, the plurality of micromirror arrays (115) may have an effective array of light patterned regions coming from the separate micromirror arrays (115). In an example, if a single micromirror array (115) (with its associated maximum cooling via the coolant) is not enough to melt the material, electromagnetic radiation directed from a plurality of micromirror arrays (115) may be focused using corrective optics so as to heat the same region of the build platform (110). This may allow for a relatively larger temperature rise of the build material compared to using a single micromirror array (115). In any example presented herein where a plurality of micromirror arrays (115) is implemented, each micromirror array (115) may be paired with its own pulsed electromagnetic radiation source (105).

In an example, the micromirror array (115) may be in the form of a digital light processing (DLP) unit. A DLP unit may be a microelectromechanical system and/or device that includes a planar arrangement of digitally steered micro-mirrors. In an example, the DLP may direct incoming electromagnetic radiation from the pulsed electromagnetic radiation source (105) into a set of parallel beams of electromagnetic radiation. Consequently, the DLP unit may be capable of providing selective illumination of the build platform (110). In any example presented herein, the pulsed electromagnetic radiation source (105), the DLP may, with the single pulsed electromagnetic radiation of the pulsed electromagnetic radiation source (105), irradiate the entire layer of build material on the build platform (110) or a subset area of the layer of build material.

In any example presented herein, the data defining any layer of the 3D object may be converted into greyscale data. In this example, the greyscale data may be data that separates any number of micromirrors of the DLP or other micromirror arrays into groups. Here, some of the micromirrors of each of the subgroups may direct the pulsed electromagnetic radiation to the build material on the build platform (110) while others are selected to direct the pulsed electromagnetic radiation towards a light dump. This greyscale data and process of fusing the build material via the greyscale data may provide the 3D printing device (100) with the ability to better control the thermal fusing of the build material in any given layer as well as among layers of build material. For example, a 3D object may be fused using less energy flux at locations within the 3D objects interior while relatively more flux energy is applied to edges of the 3D object being formed.

During operation, the micromirror array (115) receives the electromagnetic radiation from the pulsed electromagnetic radiation source (105). As described above, this electromagnetic radiation has an energy and an intensity sufficient to fuse the build material of the build material layer placed on the build platform (110). During operation, the 3D printing device (100), via execution of computer-readable program code by a processor, may estimate the energy lost when the beam of electromagnetic radiation used to irradiate the build material is reflected by the micromirror array (115). The energy lost at the micromirror array (115) may be manifested as heat that may raise the temperature of the micromirror array (115). Because the micromirror array (115) is relatively delicate and may be susceptible to damage as the temperature increases, the estimated amount of heat transfer onto the micromirror array (115) may be calculated.

In an example, a method made be used to determine the heat transferred to the micromirror array (115) and how to compensate for that heat transfer. In any example presented herein, the method may include determining the energy density used to fuse the build material to be fused. A non-exhaustive list of examples of build material that may be used may be found in Table 1 described herein. In an example, the flash energy and normalized flash energy may be based on a build platform (110) or fusible area of build material that is 3 inches by 6 inches. The method may continue with an evaluation of the energy density of the electromagnetic radiation produced by the pulsed electromagnetic radiation source (105) and focused on a 1 cm² area of micromirror array (115). In the case of the build materials described in Table 1, the following table describes the power densities impinging on the micromirror array (115) (W/cm²).

TABLE 2

| | | | Al | | | Ti |
|---|---|---|---|---|---|---|
| Build Material | PA12 | PEEK | (in AlSi₁₀Mg) | Cu | SS | (in Ti₉₀Al₆ |
| Power Density | 44,000 | 66,000 | 330,000 | 308,000 | 385,000 | 374,000 |
| impinging on DLP | | | | | | |
| (W/cm²) | | | | | | |

In an example, the method may start at an assumption that the pulsed electromagnetic radiation source (105) has an irradiation sufficient to allow for the build material fusing is projected onto 1 cm² micromirror array (115), rather than on an example 3″×6″(≈110 cm²) build platform (110) used. In this example, it may be further assumed that any optical components external to micromirror array (115) are capable of withstanding this relatively high energy densities described herein. In an example, the 3D printing device (100) may include or use a water cooled metal reflective number of elements. In the present description, it is assumed that the micro-mirrors cover the entire area of micromirror array (115). Thus, power density impinging upon the micromirror array (115) as shown in Table 2 is 110*X larger than that described in connection with Table 1.

The method may continue with an experimental assumption that the micromirror array (115) in the present examples presents an energy loss (i.e., via heat) of about 2% with the micromirror array (115) reflecting 98% of the electromagnetic radiation from the pulsed electromagnetic radiation source (105). This assumption is relatively generous in light of other optical mirrors having an energy loss of around 10%. The energy absorbed by the micromirror array (115) may then have the values as depicted in table 3.

TABLE 3

| | | | Al | | | Ti |
|---|---|---|---|---|---|---|
| Build Material | PA12 | PEEK | (in AlSi₁₀Mg) | Cu | SS | (in Ti₉₀Al₆) |
| Energy absorbed by | 880 | 1,320 | 6,600 | 6,160 | 7,700 | 7,480 |
| the micromirror array | | | | | | |
| (J/cm²) | | | | | | |

Water flow calculations below (discretization of the water movement) may be a relatively simpler way of estimating water flow conditions. These calculations avoid solving complex differential equations that may describe liquid flow while still providing an accuracy in heat dissipation adequate for removing heat from the micromirror array (115). These calculations assume that volume V of water is placed in contact with the 1 cm² micro-mirror array at time=0 second by flowing it through an imaginary aperture. Energy “Q” is then transferred into this volume causing its temperature increase by 5K, and finally at time=1 second volume V is replaced by a new volume V having the original water temperature.

All non-linear water transport effects are neglected (ex. laminar flow, no water compression, no water interactions with aperture edges, no consideration for the ways that water can be brought to this aperture, etc.).

Table 4 shows calculated flow rates (the same for both schemes—flow rate shown in more familiar units of L/min) and water velocities (different for each scheme) that is to be provided to attain desired cooling effect.

TABLE 4

| | | | Al | | | Ti |
|---|---|---|---|---|---|---|
| Build Material | PA12 | PEEK | (in AlSi₁₀Mg) | Cu | SS | (in Ti₉₀Al₆) |
| V (cm³) (each second) | 42 | 63 | 314 | 293 | 367 | 356 |
| Water velocity when | 0.42 | 0.63 | 3.14 | 2.93 | 3.67 | 3.56 |
| entering the 1 cm² | | | | | | |
| aperture (m/s) - | | | | | | |
| configuration (A) | | | | | | |
| Water velocity when | 0.01 | 0.01 | 0.01 | 0.01 | 0.01 | 0.01 |
| entering the 1 cm² | | | | | | |
| aperture (m/s) - | | | | | | |
| configuration (B) | | | | | | |
| Flow rate (L/min) | 2.52 | 3.78 | 18.84 | 17.58 | 22.02 | 21.36 |
| through the aperture | | | | | | |

In the examples presented above in configuration A and B, the calculated flow rates may be based on the aperture defining a volume above the micromirror arrays (115). By way of example, in connection with configuration A, the aperture is a cross-section above the micromirror array (115) and may be equal to the surface area of the micromirror array (115). In this configuration, the coolant may be passed downwards towards the micromirror array (115). Consequently, because the coolant may flow towards the micromirror array (115) and out from the sides of the micromirror array (115), a relatively higher flow rate of coolant through the coolant tank (120) is used. In another example, in connection with configuration B, the aperture may be defined by a lateral side of a cuboid shape formed between the micromirror array (115) and a side of the coolant tank proximal to the pulsed electromagnetic radiation source (105). As a result, the coolant may be caused to pass over the micromirror array (115) from a side of the micromirror array (115) and over the micromirror array (115). In this example, the flow rate of the coolant may be decreased relative to configuration resulting in a relatively slower flow rate of coolant across the micromirror array (115).

The energy absorbed by the micromirror array (115) may be transferred away, in any example, from the micromirror array (115) using a cooling agent. Thus, in an example, the micromirror array (115) may be surrounded by a tank full of a cooling agent so as to keep the micromirror array (115) from being damaged by the heat absorbed. In an example, the flow of the cooling agent in the tank may be adjusted to optimally cool the micromirror array (115).

The method may continue by selecting a cooling agent used and the flow of the cooling agent over the micromirror array (115). In an example, water may be selected as the cooling agent for a number of reasons. In an example, water is selected as a cooling agent because it is transparent to the pulsed electromagnetic radiation produced by the pulsed electromagnetic radiation source (105). In other examples, however, transparency to the pulsed electromagnetic radiation of the pulsed electromagnetic radiation source (105) may be a characteristic of a type of cooling agent used. In an example, water is selected as a cooling agent because of the heat transfer coefficient of the water. The heat transfer coefficient of water is relatively higher than that of, for example, forced air cooling. Other examples of coolants may be used other than water including, but not limited to ethylene glycol. A characteristic of these other types of coolants may include transparency to the irradiation energy of the pulsed electromagnetic radiation source (105) and relatively good heat conductivity. The coolants may be maintained within a coolant tank (120) as described herein.

The method may further include calculating the energy transfer using the coolant such as the water described herein. In this example, the energy transfer from the micromirror array (115) to the coolant may be described as:

Q=ΔT·cₚ·m=ΔT·cₚ·ρV

Where Q=the energy that is to be removed by the coolant (which may be equal to the energy loss at the micromirror array (115)); DT is an allowed temperature increase for the micromirror array (115); cₚ is the specific heat of the coolant (cₚ of water being equal to 4.2 J/gK); and m is the mass of the coolant used to provide the heat transfer (m=ρV, where ρ=water density=1 g/cm3, V=volume of water used to provide desired heat transfer and V is volume with base area of 1 cm² of the micromirror array (115).

In any example presented herein, the light dump may receive reflected electromagnetic radiation from the micromirror array (115). By receiving the electromagnetic radiation, the heat dump may prevent other portions of the 3D printing device (100) from being exposed to the reflected electromagnetic radiation thereby decreasing these other parts of the 3D printing device (100). In an example, the light dump may be cooled by the coolant in the coolant tank and systems associated with the coolants that cool the micromirror array (115). In an example, the light dump may have an independent cooling system that may include its own dedicated coolant and devices.

In any example, the 3D printing device (100) may further include corrective optics. In an example, the corrective optics may receive the reflected electromagnetic radiation from the micromirror array (115) and direct the electromagnetic radiation to the build material layered onto the build platform (110). Corrective optics may include any optics that collimate, reflect, expand or focus the electromagnetic radiation. In a specific example, the corrective optics may include a reflective mirror that retains a parallel beam irradiation of the build platform (110) in order to attain a uniform energy density over the build material on the build platform (110).

In an example, corrective optics may be placed between the pulsed electromagnetic radiation source (105) and the micromirror array (115). In this example, the corrective optics may expand the cross-sectional area of the beam emitted from the pulsed electromagnetic radiation source (105) onto the micromirror array (115). This may be done in order to maintain a uniform energy distribution across the micromirror array (115) within the beam so as to lower the cross-sectional energy density that is applied to the micromirror array (115). Additionally, in this example, the amount of energy received by each of the micromirrors in the micromirror array (115) may be equal. The size or number of the micromirror arrays (115) used may be increased or decreased in order to match a degree to which the electromagnetic radiation beam from the pulsed electromagnetic radiation source (105) is expanded. This may be done in order to protect the micromirrors within the micromirror array (115) from heat damage.

In an example, additional corrective optics, as described herein, may be placed between the micromirror array (115) and the build platform (110) in order to reduce the cross-sectional energy density of the electromagnetic radiation applied to the build platform (110). In an example, the reduction of the cross-sectional area of the electromagnetic radiation beam may be done so as to match the size of the build platform (110). In this manner, the energy per area applied to the micromirror array (115) using a first set of corrective optics is used reduce the heat applied to the micromirror array (115) while reducing the beam of electromagnetic radiation onto the build platform (110).

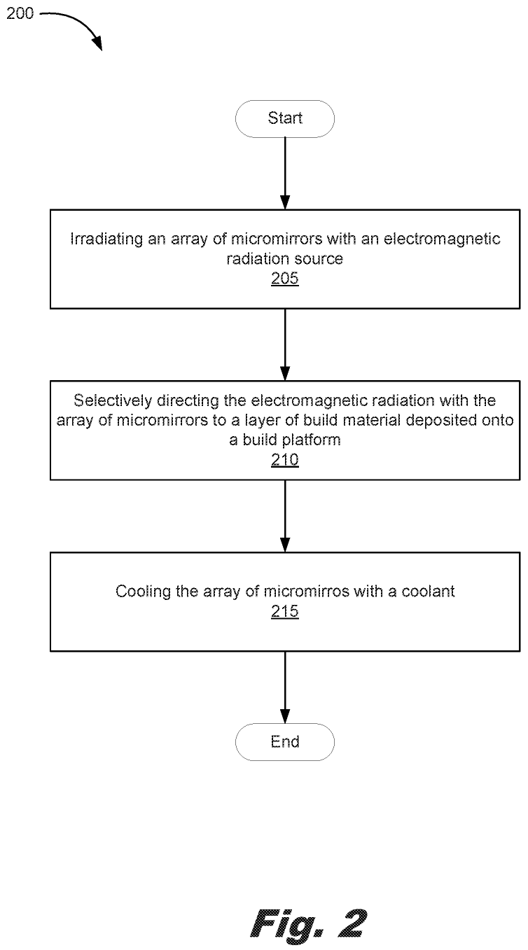

FIG. 2 is a block diagram of a method (200) of fusing a build material according to an example of the principles described herein. The method (200) may include irradiating (205) an array of micromirrors with an electromagnetic radiation source. As described herein, the array of micromirrors may include a DLP with the electromagnetic radiation source including a pulsed electromagnetic radiation source such as a Xenon electromagnetic radiation source. The irradiation (205) of the micromirror array (FIG. 1, 115) may include a pulse irradiation lasting 10 ms or less.

The method (200) may include selectively directing (210) the electromagnetic radiation with the array of micromirrors to a layer of build material deposited onto a build platform. The selectivity of the micromirror array (FIG. 1, 115) allows for, in an example, a bimodal arrangement of each of the individual micromirrors of the micromirror array (FIG. 1, 115): either directed to the build platform (FIG. 1, 110) (“on”) or directed away from the build platform (FIG. 1, 110) and towards the light dump (“off”). In some examples, the individual micromirrors may be infinitely modal such that each of the individual micromirrors of the micromirror array (FIG. 1, 115) may be directed at any location and specifically at any location on the build platform (FIG. 1, 110) and/or corrective optics.

In an example, subsets of the micromirrors of the micromirror array (FIG. 1, 115) may be used to direct (210) the electromagnetic radiation towards selected surface areas of the build platform (FIG. 1, 110) to vary a degree of irradiation within the selected surface areas. For example, the greyscale operation described herein may be used to control specific irradiation characteristics of an area within the build platform (110) area.

The method (200) may further include cooling (215) the array of micromirrors with a coolant. As described herein, the coolant may be water. In this example, a tank may be formed around the micromirror array (FIG. 1, 115) and allowed to flow across the micromirror array (FIG. 1, 115) as described herein. In an example, a light dump may be cooled (215) with the micromirror array (FIG. 1, 115). In any example presented herein, the tank may include a window through which the electromagnetic radiation from the electromagnetic radiation source. The medium that the tank is made of may take into considerations such as electromagnetic radiation diffraction properties and electromagnetic radiation refraction properties.

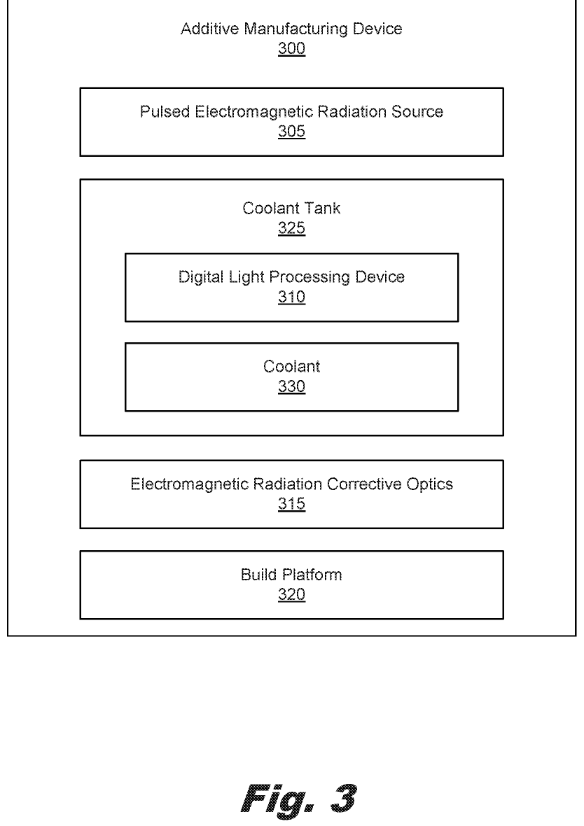

FIG. 3 is a block diagram of an additive manufacturing device (300) according to an example of the principles described herein. The additive manufacturing device (300) may include a pulsed electromagnetic radiation source (305), a digital light processing device (310) maintained within a coolant tank (325) full of coolant (330), electromagnetic radiation corrective optics (315), and a build platform (320). In addition to the 3D printing device described in connection with FIG. 1, the additive manufacturing device (300) may include the electromagnetic radiation corrective optics (315) to retain parallel beam irradiation of the build platform (320). The corrective optics (315), therefore, ensure uniform energy density and irradiation of the build material over the build platform (320).

The additive manufacturing device (300) may further include as a micromirror array a digital light processing (DLP) device (310). The DLP device may be a microelectromechanical device that includes a planar arrangement of digitally steered micromirrors. In an example, the DLP device (310) may direct incoming electromagnetic radiation from the pulsed electromagnetic radiation source (305) into a set of parallel beams of electromagnetic radiation. Consequently, the DLP device (310) may be capable of providing selective illumination of the build platform (320). In any example presented herein, the pulsed electromagnetic radiation source (305), the DLP device (310) may, with the single pulsed electromagnetic radiation of the pulsed electromagnetic radiation source (305), irradiate the entire layer of build material on the build platform (320) or a subset area of the layer of build material. As described herein, the DLP device (310) may be maintained within a coolant tank (325) and surround by a coolant (330) such as water. The coolant (330) may be circulated into and out of the coolant tank (325) and/or around the DLP device (310).

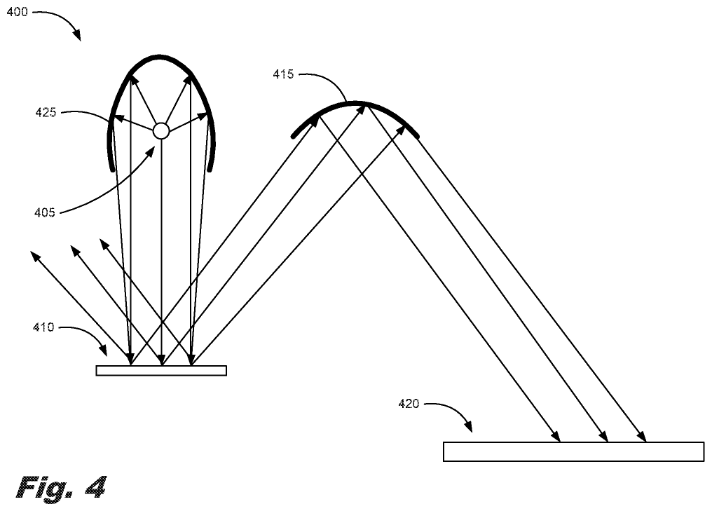

FIG. 4 is a schematic diagram of an additive manufacturing device (400) according to an example of the principles described herein. The additive manufacturing device (400) may include a pulsed electromagnetic radiation source (405), an array of micromirrors (410), corrective optics (415), and a build platform (420) as described herein. Although the arrangement of the pulsed electromagnetic radiation source (405), array of micromirrors (410), corrective optics (415), and build platform (420) may be shown to be specific, the present specification contemplates that, according to reflection and refraction principles, these elements may be arranged differently as shown.

The pulsed electromagnetic radiation source (405) may include, itself, a mirror (425) that is used to reflect the electromagnetic radiation towards the array of micromirrors (410) as described herein. A series of lines shown in FIG. 4 between the pulsed electromagnetic radiation source (405), the array of micromirrors (410), the corrective optics (415), and the build platform (420) may indicate the traveled path of the electromagnetic radiation during operation of the additive manufacturing device (400). As depicted, the electromagnetic radiation from the pulsed electromagnetic radiation source (405) may be selectively directed towards the corrective optics (415) which is then directed towards the build platform (420). Alternatively, the electromagnetic radiation may be directed away from the corrective optics (415) and is made to not reach the build material layered over the build platform (420) thereby not fusing the build material.

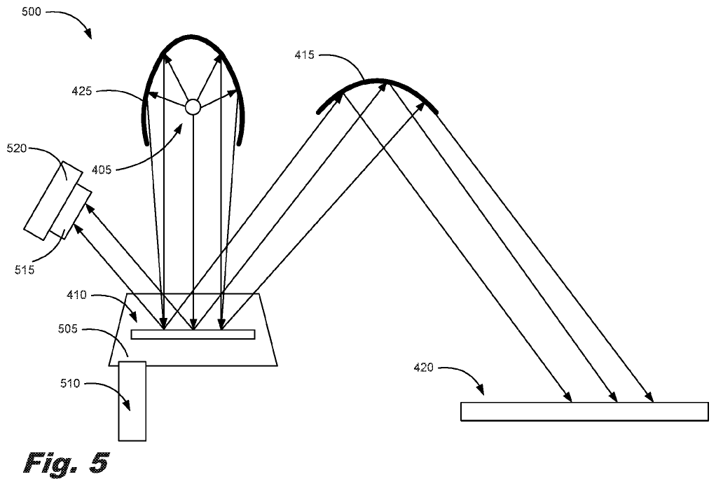

FIG. 5 is a schematic diagram of an additive manufacturing device (500) according to an example of the principles described herein. FIG. 5 has similar elements of those shown in FIG. 4 with the addition of a coolant tank (505) holding a coolant, a coolant pump (510), a heat dump (515), and a heat dump cooling device (520).

The coolant tank (505), as described herein, may hold an amount of coolant around the array of micromirrors (410). In an example, the coolant is water that is pumped around the array of micromirrors (410) via a coolant pump (510). The coolant tank (505) and coolant pump (510) maintains constant water temperature and provides water circulation within the coolant tank (505) in order to transfer heat from the array of micromirrors (410) to the coolant. In an example the heat dump (515) may further include a heat dump cooling device (520) similar to the coolant tank (505) and coolant pump (510) described. The heat dump cooling device (520) removes the heat resulting from the electromagnetic radiation absorption from the array of micromirrors (410) and dissipates it in a manner so as to not affect the performance of the additive manufacturing device (500). In an example both the heat dump (515) and array of micromirrors (410) may include Peltier coolers.

Because an overall irradiation energy form the pulsed electromagnetic radiation source (405) is selected to achieve desired build material fusing and it is projected onto the array of micromirrors (410) in a uniform fashion (uniform energy density over the entire area of array of micromirrors (410)), effective increase of the array of micromirror (410) area (by using a plurality of arrays of micromirrors (410) instead of a single array of micromirrors (410)) provides a lower energy density impinging on a unit area of the array of micromirrors (410) and reduces array of micromirrors (410) cooling. For example, using an array of 50×50 standard DLP units (each 1 cm²—total area of the array equal 50 cm×50 cm) lowers the numbers shown in Table 2 by factor of 2,500. Thus, assuming the same power loss (2%) on each micromirror energy that is to be dissipated by each of the 2,500 DPL units is also decreased 2,500 times. As such it is becoming much more manageable, as shown in Table 5.

TABLE 5

| | | | Al | | | Ti |
|---|---|---|---|---|---|---|
| Build Material | PA12 | PEEK | (in AlSi₁₀Mg) | Cu | SS | (in Ti₉₀Al₆) |
| Energy absorbed by the | 0.35 | 0.53 | 2.64 | 2.46 | 3.1 | 3.0 |
| micromirror array (J/cm²) | | | | | | |

Table 6 shows the results of the analogous water flow calculations (compare with Table 4).

| | | | Al | | | Ti |
|---|---|---|---|---|---|---|
| Build Material | PA12 | PEEK | (in AlSi₁₀Mg) | Cu | SS | (in Ti₉₀Al₆) |
| V (cm³) | 0.017 | 0.025 | 0.126 | 0.117 | 0.148 | 0.143 |
| (each second) | | | | | | |
| Water velocity when | 0.00017 | 0.00025 | 0.0013 | 0.0012 | 0.0015 | 0.0014 |
| entering the 1 cm3 | | | | | | |
| aperture (m/2) - | | | | | | |
| configuration (A) | | | | | | |
| Water velocity when | 0.01 | 0.01 | 0.01 | 0.01 | 0.01 | 0.01 |
| entering the 1 cm2 | | | | | | |
| aperture (m/s) - | | | | | | |
| configuration (B) | | | | | | |
| Flow rate (L/min) | 0.00102 | 0.0015 | 0.008 | 0.007 | 0.009 | 0.009 |
| through the aperture | | | | | | |

These calculations show that an increase of the effective area of the array of micromirrors (410) may allow for practical realization of the additive manufacturing device (500). Because of the relative low cost of the DLP devices described herein building array of array of micromirrors (410) should effectively reduce the costs of manufacture of the additive manufacturing device (500).

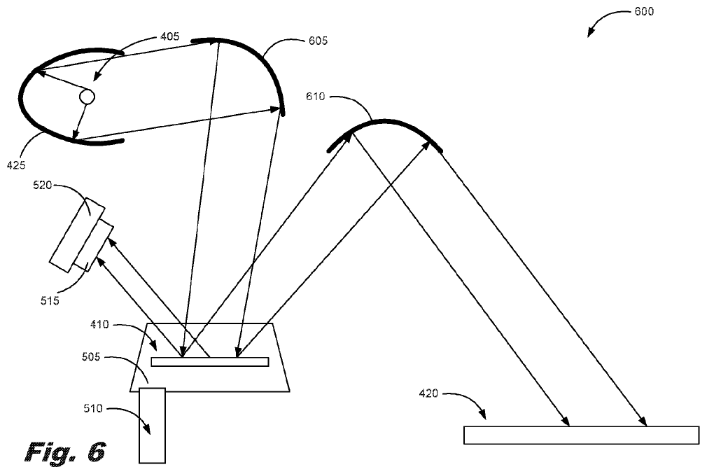

FIG. 6 is a schematic diagram of an additive manufacturing device (600) according to an example of the principles described herein. The additive manufacturing device (600) in this example includes similar elements as that in FIGS. 4 and 5 with a first corrective mirror (605) placed between the pulsed electromagnetic radiation source (405) and the array of micromirrors (410), and the second corrective mirror (610) placed between the array of micromirrors and the build platform. In this example, the surface area of the array of micromirrors (410) is less than the surface area of the build platform (420). The second corrective mirror (610) may direct the electromagnetic radiation from the array of micromirrors (410) onto the entirety of the build platform while the first corrective optics (605) directs the electromagnetic radiation from the pulsed electromagnetic radiation source (405) onto the entirety of the array of micromirrors (410) and may provide a relatively higher energy density on the array of micromirrors than on the build platform. In other examples, the surface area of the array of micromirrors (410) may be larger than that of the build platform (420) providing lower energy density on the array of micromirrors than on the build platform. In yet another example, the cross-section of the electromagnetic radiation beam cross-section emitted by the pulsed electromagnetic radiation source (405), array of micromirrors (410), and build platform (420) have the same size, and both the first (605) and second corrective optics (610) may be flat mirrors that direct the electromagnetic radiation from the pulsed electromagnetic radiation source (405), to the array of micromirrors (410) and from the array of micromirrors (410) and the build platform (420).

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general-purpose computer, special purpose computer, or other programmable data processing apparatus to produce a machine, such that the computer usable program code, when executed via, for example, the processor of the additive manufacturing devices or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describe a 3D printing device and method of operating an additive manufacturing device. The selectively of the process of forming a 3D object using the additive manufacturing device comes from the use of the micromirror arrays described herein including a DLP device. Consequently, no ink agents such as electromagnetic radiation reflecting or absorbing agents are used with the build material to prevent or create (respectively) the fusing of the build material. The present additive manufacturing devices described may allow for a variety of build materials to be used including high fusing temperature metals. The use of the micromirror arrays provide for micromirror arrays that can be cooled sufficiently so as to not be destroyed by the high intensity pulsed electromagnetic radiation source. Additionally, the array of micromirrors may provide a relatively better control of the 3D printing process by allowing for possible greyscale image development as described.

The preceding description has been presented to illustrate and describe examples of the principles described. This description is not intended to be exhaustive or to limit these principles to any precise form disclosed. Many modifications and variations are possible in light of the above teaching.

1. A three-dimensional (3D) printing device, comprising:
a pulsed electromagnetic radiation source;
a build platform to maintain a number of layers of build material thereon and receive pulsed electromagnetic radiation from the pulsed electromagnetic radiation source;
a micromirror array to selectively direct the pulsed electromagnetic radiation from the pulsed electromagnetic radiation source to the build material on the build platform; and
a coolant tank with coolant therein to cool the micromirror array.

2. The 3D printing device of claim 1, further comprising corrective optics to receive the pulsed electromagnetic radiation from the pulsed electromagnetic radiation source and achieve a level of beam irradiation of the build material on the build platform.

3. The 3D printing device of claim 2, wherein the corrective optics is used to change a cross-section of a pulsed electromagnetic radiation beam of the pulsed electromagnetic radiation source and respectively change a cross-sectional energy density within the pulsed electromagnetic radiation while maintaining uniform energy density within the cross-section of the electromagnetic radiation pulse.

4. The 3D printing device of claim 1, wherein the cooling tank surrounds the micromirror array, the cooling tank comprising a coolant recirculating system to recirculate the coolant through the cooling tank.

5. The 3D printing device of claim 4, wherein the flow of the coolant through the cooling tank is dependent on:
characteristics associated with the build material;
the volume of the coolant tank;
characteristics of the coolant;
characteristics of the pulsed electromagnetic radiation source;
characteristics of the micromirror array;
or combinations thereof.

6. The 3D printing device of claim 1, wherein the micromirror array may comprise a plurality of digital light processors (DLPs) assembled into a configurable planar array, wherein each DLP comprises of a plurality of micromirrors

7. A method of fusing a build material, comprising:
irradiating an array of micromirrors with an electromagnetic radiation source;
selectively directing the electromagnetic radiation with the array of micromirrors to a layer of build material deposited onto a build platform; and
cooling the array of micromirrors with a coolant.

8. The method of claim 7, wherein selectively directing the electromagnetic radiation to the layer of build material comprises, with a micromirror, directing the electromagnetic radiation to a heat dump.

9. The method of claim 7, wherein cooling the array of the micromirrors with the coolant comprises flowing the coolant through a coolant tank formed around the array of micromirrors.

10. The method of claim 7, comprising directing selected subsets of micromirrors to direct the electromagnetic radiation towards selected surface areas of the build platform to vary a degree of irradiation within the selected surface areas.

11. The method of claim 7, wherein irradiating the array of micromirrors includes a pulse irradiation lasting 10 ms.

12. The method of claim 7, comprising directing the electromagnetic radiation via a reflective mirror intermittent to the electromagnetic radiation source and the build material capable of changing a cross section of the electromagnetic radiation beam while maintaining uniform energy distribution within the cross section of the electromagnetic radiation beam.

13. An additive manufacturing device, comprising:
a pulsed electromagnetic radiation source;
a digital light processing device maintained within a coolant tank full of coolant;
electromagnetic radiation corrective optics; and
a build platform to receive a layer of build material;
wherein the pulsed electromagnetic radiation source reflects electromagnetic radiation off the digital light processing device, towards the electromagnetic radiation corrective optics, and to the build material on the build platform to selectively fuse the build material.

14. The additive manufacturing device of claim 13, further comprising a cooling tank surrounding the digital light processing device, the cooling tank comprising a coolant recirculating system to recirculate the coolant through the cooling tank.

15. The additive manufacturing device of claim 14, wherein the flow of the coolant through the cooling tank is dependent on:
characteristics associated with the build material;
the volume of the coolant tank;
characteristics of the coolant;
characteristics of the pulsed electromagnetic radiation source;
characteristics of the micromirror array;
or combinations thereof.
